(19) United States
(12) Patent Application Publication
(10) Pub. No.: US 2015/0162127 A1
(43) Pub. Date: Jun. 11, 2015

(54) TRANSFORMER USED FOR STORING AND FILTERING

(71) Applicant: Hella KGaA Hueck & Co., Lippstadt (DE)

(72) Inventor: Wolfgang Daub, Anrochte (DE)

(73) Assignee: Hella KGaA Hueck & Co., Lippstadt (DE)

(21) Appl. No.: 14/414,049

(22) PCT Filed: Jun. 29, 2013
(86) PCT No.: PCT/EP2013/063751

§ 371 Date: Jan. 9, 2015

(30) Foreign Application Priority Data
Jul. 12, 2012 (DE) 10 2012 106 260.9

(51) Int. Cl. H01F 30/12; H01F 38/42

(52) U.S. Cl. CPC H01F 30/12; H01F 38/42; H01F 2038/426

(57) ABSTRACT

A multi-phase stray field transformer used for storing energy and filtering currents with a number of 2*n+1 phases, wherein “n” represents a natural number, comprising a core (11, 12, 13, 14) with 2*n+1 of first yokes (11, 11a) with one winding (2) arranged on every first yoke and with at least one additional (second) yoke (12) that is connected to the rest of the core (13, 14) across an air gap (3) and/or exhibits such an air gap (3) with the core (11, 12, 13, 14) of the transformer being provided with 2*n second yokes (12) that are arranged with the first yokes (11) in an alternating fashion.

### CROSS REFERENCE

This application claims priority to PCT/EP2013/063751, filed Jun. 29, 2013, which itself claims priority to German Application No. 10 2012 106260.9, filed Jul. 12, 2012, which are both hereby incorporated by reference.

### FIELD OF TECHNOLOGY

The invention concerns a multi-phase transformer used for storing energy and filtering currents in a DC/DC converter with a number of 2*n+1 phases, wherein “n” represents a natural number, comprising a core with 2*n+1 of first yokes with one winding arranged on every first yoke and with at least one additional (second) yoke that is connected to the rest of the core across an air gap and/or exhibits such an air gap.

### BACKGROUND

The essay “Coupled Inductor Design Optimization for Fast-Response LowVoltage DC-DC Converters” by Jieli Li and C. R. Sullivan at the IEEE Applied Power Electronics Conference of March 2002 describes such a transformer assembly/arrangement.

This transformer assembly is equipped with a core that is designed in a fashion that is similar to a “ladder”. The rungs of this ladder-like core are formed by the first yokes of the transformer. In addition to the first yokes, a second yoke is provided that also has the air gap necessary for the storing the energy as required. The transformer can thereby be integrated into a multi-phase system in such a manner that every winding is traversed by the current of one of the phases, as is the case for current-compensated multi-phase transformers in accordance with the state-of-the-art.

While an even number of phases and therefore an even number of windings and first yokes allows the core to be designed in such a manner that the first yokes are arranged symmetrically to the second yoke, this is not possible when using an uneven number of yokes. The second yoke cannot be positioned in the center of a symmetrical core. This is considered disadvantageous with regard to the emission of electromagnetic interference and can lead to unwanted transient phenomenons.

### SUMMARY OF THE INVENTION

The invention's objective is to improve a transformer of the type and manner mentioned in the introduction in such a way that a higher degree of EMC is attained and that transient conditions or phenomenons do not occur or only do so in a greatly reduced manner.

This objective is achieved in accordance with the invention by providing the core of the transformer with 2*n second yokes that are alternatingly arranged in combination with the first yokes.

With the solution in accordance with the invention, it as possible to create a symmetrical core and therefore a symmetrical transformer as a whole. A transformer in accordance with the invention has to first yoke positioned in the center. The second yoke and the other first yokes are arranged in symmetry with this first yoke, with the first center yoke initially assigned the second yokes where the other first and second yokes are then added in an alternating fashion.

The first and second yokes should preferably be positioned in parallel to one another. The parts of the core that connect the yokes should also be advantageously arranged in parallel.

In accordance with the invention, it is possible that all air gaps have the same degree of expansion.

The core of the transformer should preferably be magnetically soft.

The windings can be planar windings. It is also possible that the windings are wound from wire.

Every first yoke can be connected with the rest of the core without an air gap. Likewise, it would be preferable if no air gap would be provided within the first yokes.

Every first yoke can alternatively be connected to the core with a gap, particularly an air gap, and/or a gap within the first yoke, particularly an air gap, though this gap would be very small in comparison with the air gaps attributed to the second yokes.

In accordance with the invention, the central one of the first yokes can be connected with the rest of the core by a gap and/or a gap be provided within the first yoke that is larger than the gap on or within the other first yokes. The width of the gap on or within the first central yoke may amount to 100 pm.

The gap on or within the first yokes, including the central first yoke, can be completely or partially filled with at least one super paramagnetic, ferrimagnetic, ferromagnetic or at least magnetically soft solid object. This solid object might for example be a film or foil. It would also be possible to use balls/spheres that are embedded using an adhesive as solid objects. The object/objects might also be made of glass.

An advantage of gaps on or within the first yokes is the fact that the inductance of the windings can be adjusted using the width of the gap. The selection of a gap width for a gap on or within the first central yoke that is larger than the gap in or within the other first yokes can particularly serve to achieve that the inductance of all windings is equal, which additionally improves the transient response after a change in voltage or load.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a sectional drawing of a transformer with wire winding as a schematic representation.

FIG. 2 shows a sectional drawing of a transformer with conducting paths arranged on circuit carriers as planar windings and

FIG. 3 shows a sectional drawing of a transformer with wire winding and gaps on the first yokes as a schematic representation

### DETAILED DESCRIPTION OF THE DRAWINGS

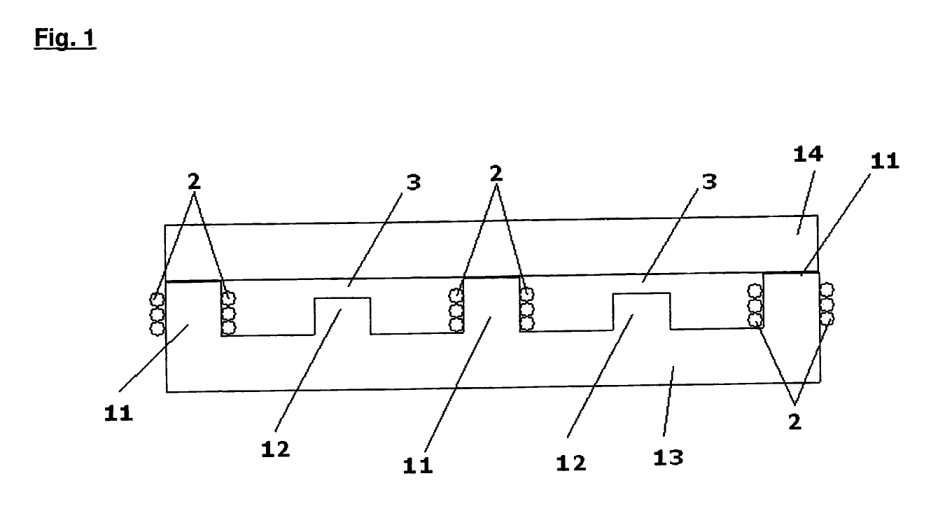

The transformers portrayed in FIGS. 1, 2 and 3 show a core (11, 12, 13, 14) that consists of first yokes (11), second yokes (12), a fixed side component (13) and an attached side component (14). The yokes (11, 12) are firmly connected with the fixed side component (13) and extend from the fixed side component (13) at an angle of approximately 90°. The core has three first yokes (11), of which one is arranged in the center. The other yokes (11, 12) are arranged in parallel to this central first yoke (11) and in such a manner that a second yoke (12) and a first yoke (11) alternate on every side.

There are windings (2) on all first yokes (11), which have the same number of windings as is known from current-compensated multi-phase transformers in accordance with the state-of-the-art.

The second yokes (12) are designed to be shorter than the first yokes (11) when viewed from the perspective of the fixed side component. This leads to the circumstance that there is an air gap between the second yoke (12) and the attached side component (14), in which energy can be stored as it is common with conventional storage transformers. The first yokes (11) are, on the other hand, directly in contact with the attached side component.

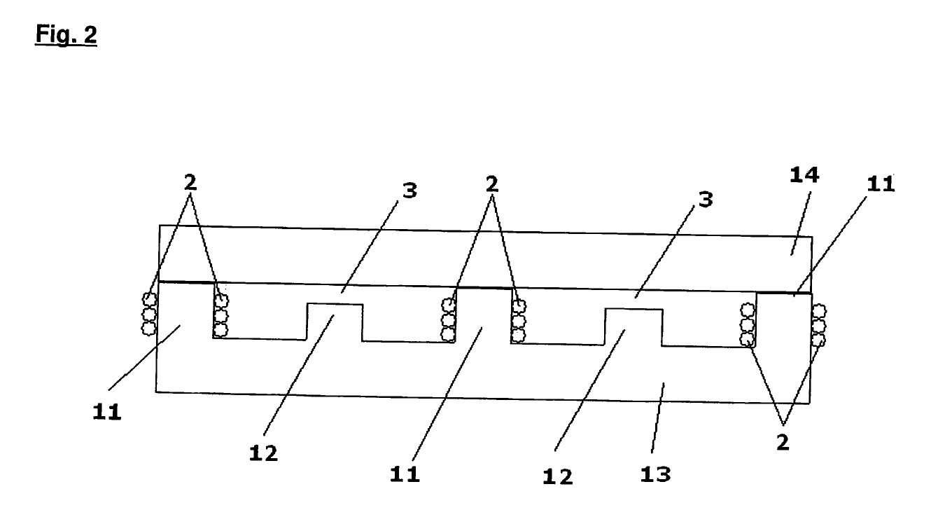

The transformers shown in FIGS. 1 and 2 are primarily distinguished from one another by the design and formation of the windings. While the windings used in the transformer in accordance with FIG. 1 are wire windings, the transformer in accordance with FIG. 2 uses conducting paths that are fitted to a circuit carrier, so-called planar windings.

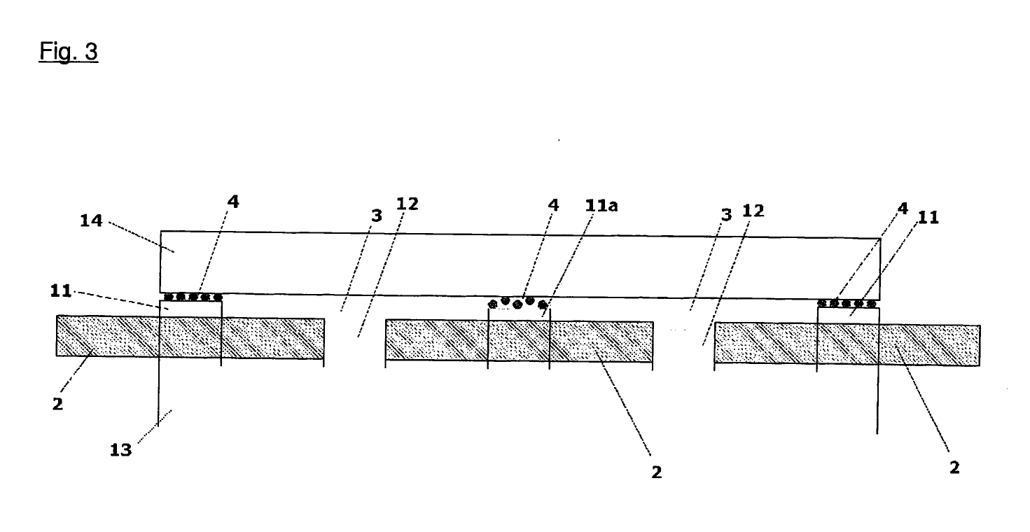

The transformers shown in FIGS. 1 and 3 are primarily distinguished from one another by using glass balls/spheres that are glued into the gaps (4) between the first yokes (11) and the attached side component using an adhesive. In this regard, the gap (4) provided on the first center yoke (11a) is slightly larger than the gap (4) that is provided between the other first yokes (11) and the attached side component (14). The slightly larger gap (4) between the first center yoke (11a) and the attached side component (14) particularly serves to achieve that the inductances of the windings (2) are equal.

### LIST OF REFERENCE SIGNS

11 First yoke of the core

11a First central yoke of the core

12 Second yoke of the core

13 Fixed side component of the yoke

14 Attached side component of the yoke

2 Windings

3 Air gap

4 Gap

1. A multi-phase stray field transformer used for storing energy and filtering currents with a number of 2*n+1 phases, wherein “n” represents a natural number>0, comprising:
a core with 2*n+1 of first yokes (11, 11a) with one winding arranged on every first yoke and with at least a second yoke that is connected to the rest of the core across an air gap exhibits such an air gap.
wherein the core of the transformer comprises 2*n second yokes, which are arranged in combination with the first yokes in an alternating manner.

2. The transformer in accordance with claim 1, wherein the first yokes and the second yokes are arranged in parallel with each other.

3. The transformer in accordance with claim 1 wherein all air gaps have the same degree of expansion.

4. The transformer in accordance with claim 1 wherein the core is magnetically soft.

5. The transformer in accordance with claim 1 wherein the windings are planar windings.

6. The transformer in accordance with claim 1 wherein the windings are wound from wire.

7. The transformer in accordance with claim 1 wherein every first yoke is connected to the rest of the core without an air gap and that no air gap is provided within the first yokes either.

8. The transformer in accordance with claim 1 wherein the first yoke is connected to the rest of the core by a gap and/or a gap is provided within the first yokes whereas this gap is very small in comparison with the air gaps assigned to the second yokes.

9. The transformer in accordance with claim 8, wherein the central one of the first yokes is connected to the rest of the core by a gap and/or a gap is provided within the first central yoke that is larger than the gap on or within the other first yokes.

10. The transformer in accordance with claim 9, wherein the gap on or within the first yoke, including the first central yoke is fully or partially filled with a magnetically soft solid object, which can be either ferromagnetic, ferrimagnetic or superparamagnetic.

11. The transformer in accordance with claim 8, wherein the first gap is filled with an adhesive.

12. The transformer in accordance with claim 10 wherein the adhesive is filled with a magnetically soft material.

13. The transformer in accordance with claim 10 wherein the filling material of the adhesive is shaped to form spheres while these spheres have a diameter that corresponds to the smaller gaps.

14. The transformer in accordance with claim 11 wherein the adhesive is filled with a magnetically soft material.
